(19) United States
(12) Patent Application Publication
(10) Pub. No.: US 2003/0218387 A1
(43) Pub. Date: Nov. 27, 2003

(54) Safety monitor for machinery

(76) Inventor: Christopher Higgins, Lancashire (GB)

Correspondence Address: PHILIP O. POST, INDEL, INC., PO BOX 157, RANCOCAS, NJ, 08073, US

(21) Appl. No.: 10/375,279

(22) Filed: Feb. 27, 2003

(30) Foreign Application Priority Data
Mar. 1, 2002 (GB) GB 0204838.7

(51) Int. Cl. H01H 35/00; H02B 1/24

(52) U.S. Cl. 307/119

(57) ABSTRACT

There is described a safety monitor for machinery comprising a pressure sensitive monitor switch mountable in the vicinity of the machinery and having first and second switching contacts which are normally separated but are arranged to be brought together in response to pressure upon the monitor switch indicative of a potential emergency, and at least one solid state switching device having first and second device inputs and at least one device output, the solid state switching device being controlled by voltage across the device inputs, which are connected across supply terminals connectable to a power supply, the first and second switching contacts of the monitor switch being respectively connected to the device inputs so that while the monitor switch is open circuit a voltage from the power supply is applied to the solid state switching device to maintain it in a first state indicative of normal operation whereas application of pressure to the monitor switch brings the switching contacts together providing a reduced resistance path across the device inputs and so reducing the voltage across them, thereby causing the output of the solid state switching device to change to a second state indicative of a potential emergency, the monitor switch and the solid state switching device being integrated in a single unit having outputs connectable to a control for initiating emergency action in response to the solid state switching device's second output state.

### CROSS REFERENCE TO RELATED APPLICATIONS

Not applicable.

### FFIELD OF THE INVENTION

The present invention concerns a safety monitor for machinery.

### BACKGROUND OF THE INVENTION

Regulations governing the use in industry of potentially hazardous machinery require in some instances provision of automatic safety monitoring. For example pressure sensitive monitor switches may be arranged around a machine to detect the weight of a person approaching it and to cause the machine to shut down in response. Alternatively, a pressure-sensitive monitor switch may be fixed to a moving part, such as a powered door, such that when the switch contacts a person the door movement is stopped or reversed. Suitable pressure sensitive switches are commercially available. TAPESWITCH LTD., Chorley, UK, supplies such switches in “safety mat” and “sensing edge” form. Both types use a pair of switching contacts normally separated from each other. A switching edge uses two parallel elongate ribbons of resilient metal. A safety mat uses an array of such ribbons or contacts of resilient sheet metal. In both cases insulative spacers separate the two switching contacts so that only upon application of pressure are they brought together to indicate a potential emergency. The switching contacts are contained in a flexible skin.

The output from the switch typically serves as an input to an electronic control, formed as a separate unit, which in turn provides a signal to either enable normal machine operation or to cause emergency action to be taken, such as shutting down the machine. Control of modern machinery is typically effected through a data bus, in which case the control is formed as a bus remote I/O block. Alternatively the control may simply be a safety relay for cutting off machine power.

It is highly important, not least in order to comply with regulations, that the safety monitor should be failsafe. That is, so far as possible any malfunction of the safety monitor should lead to the action required in a potential emergency—e.g. the machinery being shut down—as opposed to leaving the machinery running normally with the monitor inoperative.

If the control were directly connected to the monitor switch then it would detect either an open or short circuit, the former corresponding to a normal condition and the latter to a potential emergency. This would not be a failsafe mode of operation since failure of the connection from monitor switch to control—due e.g. to severing of the wires or simple disconnection of the switch—would make the monitor inoperative without causing emergency action.

Instead, it is known to connect the monitor switch to the control through an intermediate unit in which the sense of the monitor switch is inverted. Known intermediate units use an electromechanical relay whose solenoid is in the normal (non-emergency) condition driven from a DC source to maintain its relay contacts in a closed state. The associated control interprets this closed state of the relay contacts as being indicative of normal operating conditions. Closing of the monitor switch short circuits the solenoid to thereby allow the relay contacts to become open circuit and the control is such as to interpret this condition as indicative of a potential emergency and so e.g. shut down the machine. This mode of operation is failsafe in the sense that disconnection of the intermediate unit from the control is interpreted as indicative of a potential emergency.

Problems of this known technology include the bulk and inconvenience of the three separate units used (switch, control unit and intermediate unit), with the resultant need for electrical connections between all three making installation relatively complex, and the fact that the connection from monitor switch to intermediate unit is not necessarily failsafe.

### BRIEF SUMMARY OF THE INVENTION

In accordance with the present invention, there is a safety monitor for machinery comprising a pressure sensitive monitor switch which is constructed such as to be normally open and to be closed by pressure thereupon, a monitor circuit connected to the switch, and an electrical output, the monitor circuit comprising a switching device controlled by the state of the monitor switch and connected to the output to maintain it in a first state indicative of normal operation while the monitor switch is open and to change the output to a second state indicative of a potential emergency in response to closing of the switch, the monitor circuit being incorporated into a body housing the monitor switch, the body being mountable in the vicinity of the machinery and the output contact being connectable to a control for initiating emergency action in response to the switching device's second state.

Preferably the switching device has a pair of device inputs and is controlled by voltage there across, the device inputs being connected across supply terminals of the safety monitor which are connectable to a power supply, and the monitor switch having switching contacts which are respectively connected to the device inputs so that while the monitor switch is open a voltage from the power supply is applied to the switching device to maintain the output in the first state whereas closing of the monitor switch by pressure applied thereto provides a reduced resistance path across the device inputs, reducing the voltage across them and causing the output to change to the second state.

Preferably the solid state switching device comprises a solid state relay having a pair of outputs which offer low resistance when the device is energised by application of a voltage to its inputs and become open circuit when no voltage is applied to the inputs.

Preferably the pressure sensitive switch is a safety mat or sensing edge having a housing which is at least partly resilient, the solid state switching device being contained within said housing and its output(s) being led to the exterior of said housing.

### BRIEF DESCRIPTION OF THE DRAWINGS

Specific embodiments of the present invention will now be described, by way of example only, with reference to the accompanying drawings in which:

FIG. 1(a) is a perspective, simplified illustration of chosen components of a known safety mat;

FIG. 1(b) illustrates the function of the safety mat;

FIG. 2 is a simplified diagram of a monitor circuit embodying the present invention; and

FIG. 3 is a more detailed diagram of the monitor circuit.

### DETAILED DESCRIPTION OF THE INVENTION

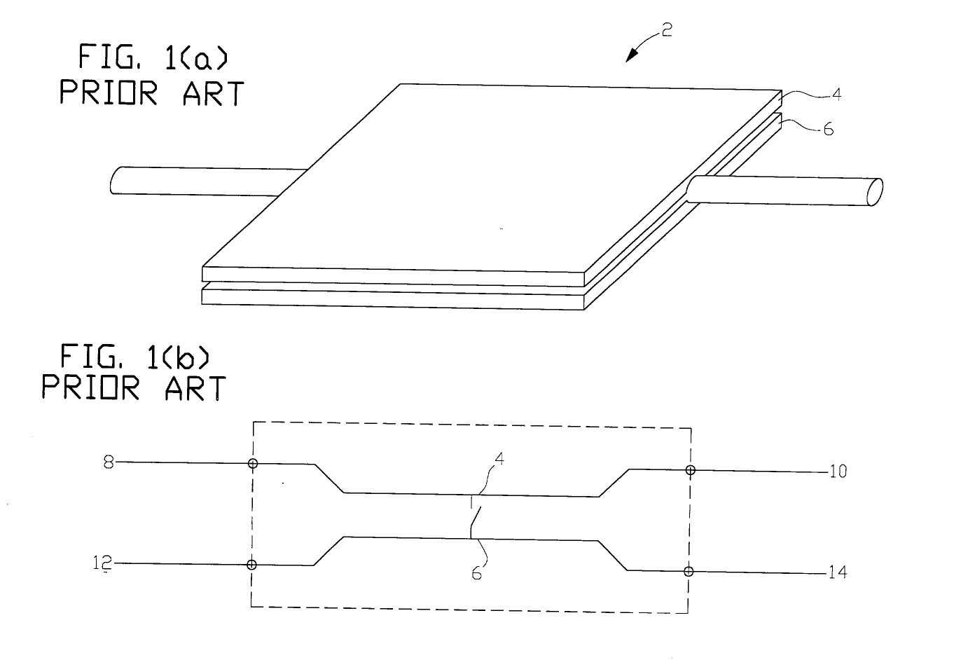

In FIGS. 1(a) and 1(b) the safety mat 2 is seen to comprise upper and lower metal plates 4, 6 serving as switching contacts which are normally separated. Pressure on the upper plate 4 closes the switch. In this form the switch has two pairs of connections 8, 10 and 12, 14, each pair being led to a respective switching contact 4, 6.

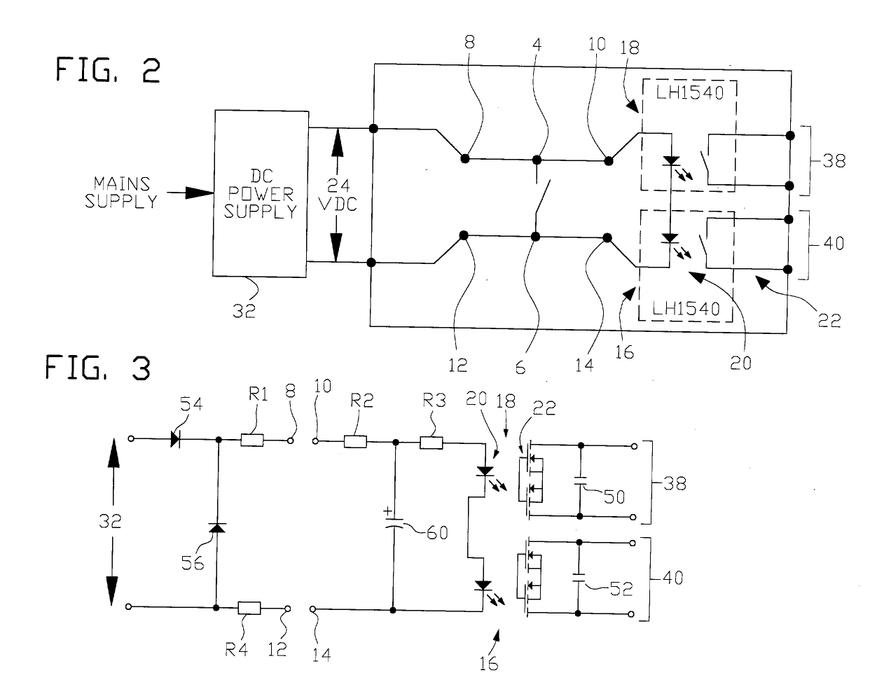

The monitor circuit illustrated in FIG. 2 uses solid state switching devices 16, 18. The device used in this particular embodiment is a solid state relay, more specifically an opto-isolator. A suitable device is available under the reference LH1540. It uses a light emitting diode (LED) 20 whose optical output controls a semiconductor junction 22 operating essentially as a switch.

In the illustrated monitor circuit a DC power supply 32 is connected to connections 8, 12 of the switching contacts 4, 6 of the monitor switch. The opposite ends 10, 14 of the switching contacts are connected across a series combination of the inputs of the two opto-isolators 16, 18. Two opto-isolators are used to provide redundancy and so increase reliability. Two pairs of monitor outputs 38, 40 are thus available for connection to a control (not illustrated) which may as in known arrangements be a safety relay or bus remote I/O block.

In the normal operating state the switching contacts 4, 6 are open circuit—i.e. not connected—and current supplied by the DC supply 32 energises the LEDs 20 of the two opto-isolators 16, 18 whose outputs are consequently switched on. That is, the pairs of outputs 38, 40 are both short circuit. This state is interpreted by the associated control as normal and the control thus enables normal running of the associated machine.

In the event of the switching contacts 4, 6 being brought together, e.g. by the weight of a person approaching the associated machine, the inputs of the opto-isolators are short circuited. Current flow through the LEDs 20 drops and the outputs of the opto-isolators are switched off. That is, the pairs of outputs 38, 40 both go open circuit. This state is interpreted by the associated control as indicative of a potential emergency and the control takes corresponding action e.g. by shutting down the machine.

The monitor is failsafe in the sense that failure or disconnection or the monitor will normally cause the control to detect an open circuit indicative of a potential emergency.

The monitor circuit is illustrated in greater detail in FIG. 3. Components common to FIGS. 2 and 3 bear the same reference numerals. Capacitors 50, 52 connected respectively across the output pairs 38, 40 provide “de-bounce” and so an improved output signal. Diodes 54, 56 connected respectively in series and in parallel with the LEDs 20 protect against improper connection. Resistors R1-R4 perform a current limiting function. Capacitor 60 serves to reduce bounce upon change in state of the monitor.

The monitor circuit can be very small in size and is housed within the same flexible skin that contains the switching contacts 4, 6. The monitor, comprising both switch and intermediate control circuitry, is thus connectable directly to the separate control unit.

1. A safety monitor for machinery comprising a pressure sensitive monitor switch which is constructed such as to be normally open and to be closed by pressure thereupon, a monitor circuit connected to the switch, and an electrical output, the monitor circuit comprising a switching device controlled by the state of the monitor switch and connected to the output to maintain it in a first state indicative of normal operation while the monitor switch is open and to change the output to a second state indicative of a potential emergency in response to closing of the switch, the monitor circuit being incorporated into a body housing the monitor switch, the body being mountable in the vicinity of the machinery and the output contact being connectable to a control for initiating emergency action in response to the switching device's second state.

2. A safety monitor as claimed in claim 1 wherein the switching device has a pair of device inputs and is controlled by voltage there across, the device inputs being connected across supply terminals of the safety monitor which are connectable to a power supply, and the monitor switch having switching contacts which are respectively connected to the device inputs so that while the monitor switch is open a voltage from the power supply is applied to the switching device to maintain the output in the first state whereas closing of the monitor switch by pressure applied thereto provides a reduced resistance path across the device inputs, reducing the voltage across them and causing the output to change to the second state.

3. A safety monitor as claimed in claim 1, wherein the switching device comprises a solid state relay having a pair of outputs which offer low resistance when the device is energised by application of a voltage to its device inputs and become open circuit when no voltage is applied to the device inputs.

4. A safety monitor as claimed in claim 1 wherein the switching device is an opto-isolator.

5. A safety monitor as claimed in claim 1 wherein the monitor circuit comprises at least two switching devices providing redundant outputs.

6. A safety monitor as claimed in claim 2, further comprising a control having inputs connected to the outputs of the solid state switching device, the control being adapted to cause emergency action upon detecting that the said outputs are open circuit.

7. A safety monitor as claimed in claim 1 further comprising a smoothing capacitor connected across the outputs of the switching device.

8. A safety monitor as claimed in claim 1 wherein the monitor switch is a safety mat or sensing edge having a housing which is at least partly resilient, the solid state switching device being contained within said housing and its output(s) being led to the exterior of said housing.
